(19) United States
(12) Patent Application Publication
(10) Pub. No.: US 2024/0154137 A1
(43) Pub. Date: May 9, 2024

(54) SHEET FRAME MODULE AND UNIT CELL FOR FUEL CELL INCLUDING THE SAME

(71) Applicants: Hyundai Motor Company, Seoul (KR); Kia Corporation, Seoul (KR)

(72) Inventors: Jin Hyeok YOO, Yongin-Si (KR); Byeong-Heon Jeong, Seoul (KR); Seung Hun Han, Osan-Si (KR); Duk Hoon Kwon, Hwaseong-Si (KR); Jong Jin Yoon, Suwon-Si (KR); Jong Hyeok Noh, Ansan-Si (KR)

(73) Assignees: Hyundai Motor Company, Seoul (KR); Kia Corporation, Seoul (KR)

(21) Appl. No.: 18/370,047

(22) Filed: Sep. 19, 2023

(30) Foreign Application Priority Data
Nov. 3, 2022 (KR) 10-2022-0145271

(51) Int. Cl. H01M 8/0273; H01M 8/0247; H01M 8/0258

(52) U.S. Cl. CPC H01M 8/0273; H01M 8/0247; H01M 8/0258

(57) ABSTRACT

A sheet frame module capable of forming an airtight line and flow path of reaction gas by bonding a plurality of sheet frames configured in a flat shape separately from a separator, and a unit cell for a fuel cell including the same, is disposed between a pair of separators for a fuel cell to form an airtight line and flow path of reaction gas, and includes a center sheet frame in which a membrane electrode assembly is disposed at a center portion thereof; a first side sheet frame disposed between one side of the center sheet frame and one of the pair of separators to form an airtight line and flow path of a first reaction gas; and a second side sheet frame disposed between the other side of the center sheet frame and another of the pair of separators to form an airtight line and flow path of a second reaction gas.

### CROSS REFERENCE TO RELATED APPLICATION

The present application claims priority to Korean Patent Application No. 10-2022-0145271, filed Nov. 3, 2022, the entire contents of which is incorporated herein for all purposes by this reference.

### BACKGROUND OF THE PRESENT DISCLOSURE

### Field of the Present Disclosure

The present disclosure relates to a sheet frame module and a unit cell for a fuel cell including the same, and more particularly, to a sheet frame module configured for forming an airtight line and flow path of reaction gas by bonding a plurality of sheet frames configured in a flat shape separately from a separator, and a unit cell for a fuel cell including the same.

### Description of Related Art

A fuel cell, which is a type of power generation device that converts chemical energy of a fuel into electrical energy through electrochemical reaction in a stack, produces electric power for small electronic devices such as portable devices as well as produces driving power for industrial use, household use, and vehicles. In recent years, die use of the fuel cell has been gradually increasing as a highly efficient and clean energy source.

FIG. 1 is a view showing the configuration of a general fuel cell stack.

As illustrated in FIG. 1, a membrane-electrode assembly (MEA) is positioned at the innermost side of a unit cell forming a general fuel cell stack. The MEA 10 includes a polymer electrolyte membrane 11 that enables hydrogen protons to move therethrough, and catalyst layers, i.e., an anode 12 and a cathode 13, respectively coated on both surfaces of the electrolyte membrane so that hydrogen and oxygen can react to each other.

Furthermore, a pair of gas diffusion layers (GDLs) 20 is stacked on outsides of the MEA 10, i.e., sides at which the anode 12 and the cathode 13 are positioned, respectively. A separator assembly 30 having a flow field formed therein is positioned on an outside surface of the GILL 20 with a gasket 40 interposed therebetween. Here, the flow field is used to supply fuel and to discharge water produced by a reaction therein.

In the instant case, the separator assembly 30 is formed by bonding an anode separator 31 disposed on the anode and a cathode separator 32 disposed on the cathode while facing each other.

On the other hand, a fuel cell stack is formed by stacking a plurality of unit cells, and an end plate 50 for supporting and fixing the respective components described above is coupled to the unit cell at the outermost side of the unit cell.

Here, the anode separator 31 disposed in one unit cell is disposed and stacked to face the cathode separator 32 of another unit cell disposed adjacent to the unit cell.

Accordingly, the unit cell is constructed with the separator assembly 30 in which the anode separators 31 and cathode separators 32 of the unit cells adjacent to each other are integrated to face each other to smoothly perform the stacking process of the unit cells and maintain the alignment of each unit cell.

In the instant case, the anode separator 31 and the cathode separator 32 forming the separator assembly 30 are bonded and integrated so that manifolds communicate with each other and have similar shapes so that the reaction surfaces are disposed at the same position.

On the other hand, on the surfaces of the anode separator 31 and cathode separator 32, the gasket 40 is formed by use of an injection molding method to form an airtight line and flow path of the reaction gas or cooling water. However, the injection molding is not formed into a desired shape in the portion where the thickness of the gasket 40 is locally thinned,

As a result, the gasket 40 may not be formed or the airtight line of the reaction gas or cooling water may be changed or broken as the adjacent gaskets 40 come into contact with each other, which cause a problem in that the reaction gas or cooling water leaks or flows in an undesirable path.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a sheet frame module configured for forming an airtight line and flow path of reaction gas by punching a plurality of sheet frames configured in a flat shape separately from a separator into a target shape and bonding them together, and a unit cell for a fuel cell including the same.

The technical problems to be addressed by the present disclosure are not limited to the technical problems described above, and therefore other technical problems may be clearly understood by those skilled in the art to which an exemplary embodiment of the present disclosure pertains from the above disclosure.

According to an exemplary embodiment of the present disclosure, a sheet frame module which is disposed between a pair of separators for a fuel cell to form an airtight line and flow path of reaction gas, includes a center sheet frame in which a membrane electrode assembly is disposed at a center portion thereof; a first side sheet frame disposed between a first side of the center sheet frame and one of the pair of separators to form an airtight line and flow path of a first reaction gas; and a second side sheet frame disposed between a second side of the center sheet frame and another of the pair of separators to form an airtight line and flow path of a second reaction gas.

The center sheet frame includes a center reaction area in which a mounting hole is formed in the center portion, and first and second surfaces of the membrane electrode assembly are exposed through the mounting hole while at least a portion of an edge portion of the membrane electrode assembly is mounted on an edge portion of the mounting hole; and a pair of center manifold areas through which a plurality of center manifold holes is passed so that reaction gas or cooling water flows to first and second sides of the center reaction area.

The first side sheet frame includes a first side reaction area formed with a first reaction area hole greater than the mounting hole in a center portion thereof, and a pair of first side manifold areas formed with a plurality of first side manifold holes fluidically-communicating with a center manifold hole on first and second sides of the first side reaction area. The second side sheet frame includes a second side reaction area formed with a second reaction area hole greater than the mounting hole in a center portion thereof, and a pair of second side manifold areas formed with a plurality of second side manifold holes fluidically-communicating with the center manifold hole on first and second sides of the second side reaction area.

The first side sheet frame includes a pair of first side flow path areas forming a flow path of the reaction gas between the first side reaction area and the pair of first side manifold areas, and the second side sheet frame includes a pair of second side flow path areas forming a flow path of the reaction gas between the second side reaction area and the pair of second side manifold areas.

The first side flow path area of the first side sheet frame includes a plurality of first flow paths extending from the first reaction area hole to be adjacent to the first side manifold holes and a plurality of first ribs disposed between the plurality of first flow paths. The second side flow path area of the second side sheet frame include a plurality of second flow paths extending from the second reaction area hole to be adjacent to the second side manifold holes and a plurality of second ribs disposed between the plurality of second flow paths.

The first flow paths and the second flow paths are formed at positions overlapping each other, and the first ribs and the second ribs are formed at positions overlapping each other.

The center sheet frame, the first side sheet frame, and the second side sheet frame are each formed in a flat sheet shape.

The center sheet frame, the first side sheet frame, and the second side sheet frame are formed of the same material.

The center sheet frame is formed of a material with higher hardness than a hardness of the first side sheet frame and the second side sheet frame.

The first side sheet frame and the second side sheet frame are formed of a material with higher elasticity than an elasticity of the center sheet frame.

Furthermore, according to an exemplary embodiment of the present disclosure, a unit cell for a fuel cell includes an electrode gas diffusion layer assembly (EGA) in which a pair of gas diffusion layers is bonded to first and second sides of a membrane electrode assembly; a first separator disposed on a first side of the EGA; a second separator disposed on a second side of the EGA; a center sheet frame in which the EGA is disposed in a center portion thereof; a first side sheet frame disposed between a first side of the center sheet frame and the first separator to form an airtight line and flow path of a first reaction gas; and a second side sheet frame disposed between a second side of the center sheet frame and the second separator to form an airtight line and flow path of a second reaction gas.

The center sheet frame includes a center reaction area in which a mounting hole is formed in a center portion thereof, and both surfaces of the EGA are exposed through the mounting hole while at least a portion of an edge portion of the EGA is mounted on an edge portion of the mounting hole, and a pair of center manifold areas through which a plurality of center manifold holes is passed so that reaction gas or cooling water flows to first and second sides of the center reaction area; the first side sheet frame includes a first side reaction area formed with a first reaction area hole greater than the mounting hole in a center portion thereof, and a pair of first side manifold areas formed with a plurality of first side manifold holes fluidically-communicating with a center manifold hole on first and second sides of the first side reaction area; the second side sheet frame includes a second side reaction area formed with a second reaction area hole greater than the mounting hole in a center portion thereof, and a pair of second side manifold areas formed with a plurality of second side manifold holes fluidically-communicating with the center manifold hole on first and second sides of the second side reaction area.

The first separator includes a first separator reaction area formed in a center portion thereof, and a pair of first separator manifold areas through which a plurality of first separator manifold holes is passed so that reaction gas or cooling water flows to first and second sides of the first separator reaction area; the second separator includes a second separator reaction area formed in a center portion thereof, and a pair of second separator manifold areas through which a plurality of second separator manifold holes is passed so that the reaction gas or cooling water flows to first and second sides of the second separator reaction area; the first separator manifold holes and the second separator manifold holes communicate with the center manifold holes.

The first side sheet frame includes a pair of first side flow path areas forming a flow path of a first reaction gas between the first side reaction area and the pair of first side manifold areas; each first side flow path area includes a plurality of first flow paths extending from the first reaction area hole to be adjacent to the first side manifold holes and a plurality of first ribs disposed between the plurality of first flow paths; the first separator includes a pair of first separator flow path areas forming a flow path of the first reaction gas between the first separator reaction area and the pair of first separator manifold areas; each first separator flow path area includes a plurality of first flow path holes through which the first reaction gas flows; the first flow path holes are formed in a portion of an area overlapping the area where the first flow path is formed.

The second side sheet frame includes a pair of second side flow path areas forming a flow path of a second reaction gas between the second side reaction area and the pair of second side manifold areas; each second side flow path area include a plurality of second flow paths extending from the second reaction area hole to be adjacent to the second side manifold holes and a plurality of second ribs disposed between the plurality of second flow paths; the second separator includes a pair of second separator flow path areas forming a flow path of the second reaction gas between the second separator reaction area and the pair of second separator manifold area; each second separator flow path area includes a plurality of second flow path holes through which the second reaction gas flows; the second flow path hole is formed in a portion of an area overlapping the area where the second flow path is formed.

Any one of the gas diffusion layers of the EGA is formed in a size corresponding to the mounting hole of the center sheet frame and disposed on an internal circumferential surface of the mounting hole.

Among the gas diffusion layers of the EGA, the gas diffusion layer disposed on the internal circumferential surface of the mounting hole is formed to have the same thickness as the center sheet frame.

According to an exemplary embodiment of the present disclosure, the airtight line and flow path of reaction gas may be formed by punching the plurality of sheet frames configured in a flat shape separately from the separator into a desired shape to replace some or all of the gaskets formed on the separator, bonding the sheet frames together, and then placing the bonded sheet frames between the pair of separators.

Therefore, by overlapping and arranging the plurality of sheet frames, the corresponding gasket shape may be easily implemented even in portions where the thickness of the gasket has to be thin conventionally, and accordingly the effect of facilitating quality control of the unit cell may be expected.

Furthermore, because it is possible to form the plurality of sheet frames with different materials and thicknesses, the sheet frame module may be formed in various shapes and methods according to the thickness and flow path depth of the EGA in which the pair of gas diffusion layers is bonded to both side surfaces of the membrane electrode assembly.

Furthermore, the sheet frame that provides the portion where the reaction gas or generated water flows directly may be made of the material with a high hardness to prevent deformation. Also, the sheet frame forming a sealing line includes a material with good elasticity, so it can absorb the tolerance of each component and are configured to improve the airtightness of the stack. Accordingly, the effect of improving the structural stability and airtightness of the stack may be expected.

Furthermore, because all of the sheet frames are made of the material with a high hardness, cell pitches may be maintained uniformly in each unit cell when stacking and fastening a plurality of unit cells, and thus an effect of reducing performance deviation between cells may be expected.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view showing the configuration of a general fuel cell stack.

FIG. 2 is a view showing a sheet frame module according to an exemplary embodiment of the present disclosure.

FIG. 3A, FIG. 3B and FIG. 3C are views showing each sheet frame forming a sheet frame module according to an exemplary embodiment of the present disclosure.

FIG. 4 is a view showing a sheet frame module and EGA according to an exemplary embodiment of the present disclosure.

FIG. 5 is a view showing a unit cell for a fuel cell according to an exemplary embodiment of the present disclosure.

FIG. 6A, FIG. 6B, and FIG. 6C are cross-sectional views of main portions of a unit cell for a fuel cell according to an exemplary embodiment of the present disclosure.

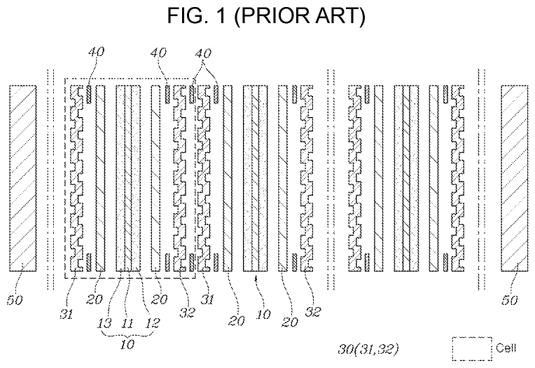

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, the exemplary embodiments included in the present specification will be described in detail with reference to the accompanying drawings, but the same reference numerals will be assigned to the same or similar components regardless of reference numerals, and overlapping descriptions thereof will be omitted.

As used herein, the suffixes “module” and “unit” are added or interchangeably used to facilitate preparation of the present specification and are not intended to suggest distinguished meanings or functions

In describing embodiments included in the present specification, a detailed description of relevant well-known technologies may not be provided in order not to obscure the subject matter of the present disclosure. Furthermore, the accompanying drawings are merely intended to facilitate understanding of the exemplary embodiments included in the present specification and not to restrict the technical spirit of the present disclosure. Furthermore, the accompanying drawings should be understood as covering all changes, equivalents or substitutions within the spirit and scope of the present disclosure.

Terms including ordinal numbers such as first, second, etc. may be used to explain various elements. However, it will be appreciated that the elements are not limited to such terms. These terms are merely used to distinguish one element from another.

Stating that one constituent is “connected” or “linked” to another should be understood as meaning that the one constituent may be directly connected or linked to another one or another constituent may be located between the constituents. On the other hand, stating that one constituent is “directly connected” or “directly linked” to another should be understood as meaning that no other constituent is located between the constituents.

A singular expression includes a plural expression unless the two expressions are contextually different from each other.

In the present specification, terms such as “includes” or “has” are intended to indicate existence of characteristics, figures, steps, operations, constituents, components, or combinations thereof included in the specification. The terms “includes” or “has” should be understood as not precluding possibility of existence or addition of one or more other characteristics, figures, steps, operations, constituents, components, or combinations thereof.

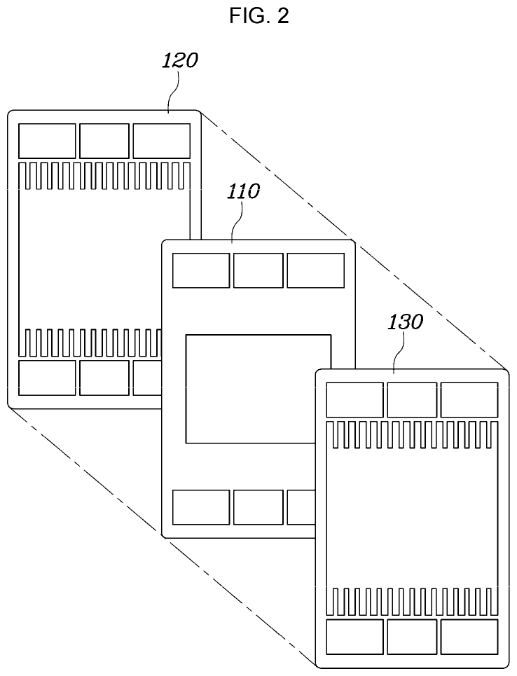

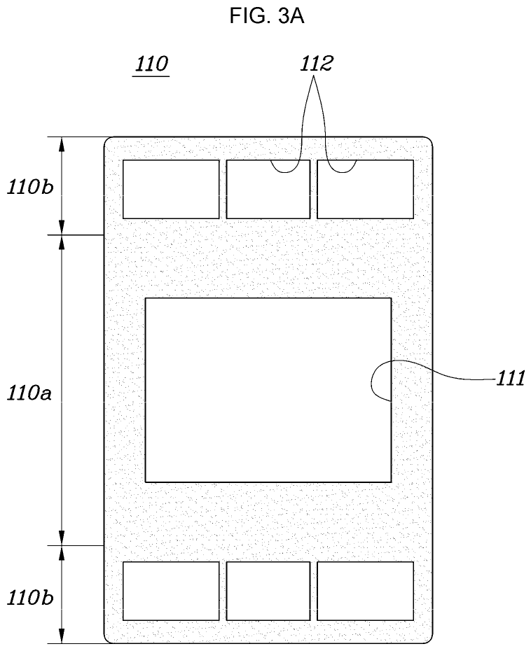

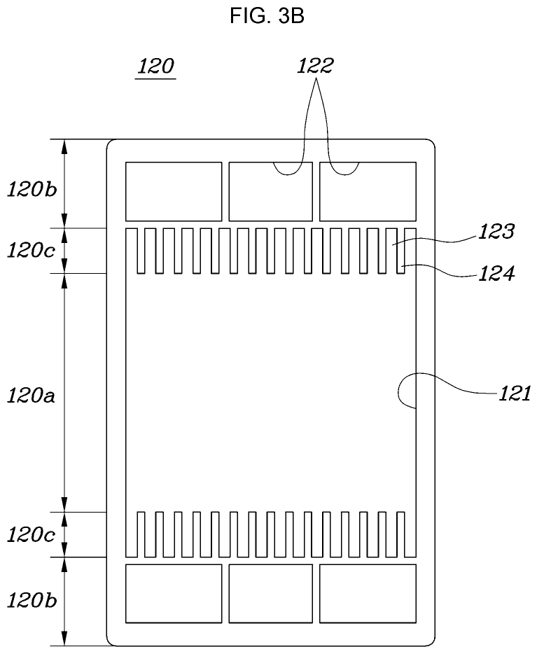

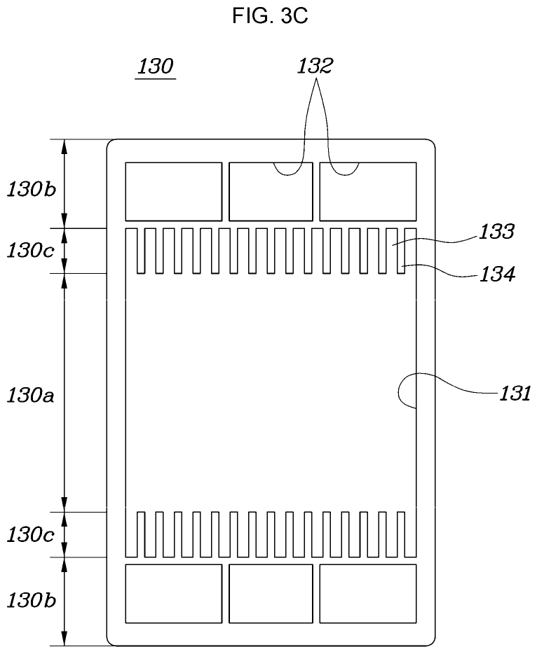

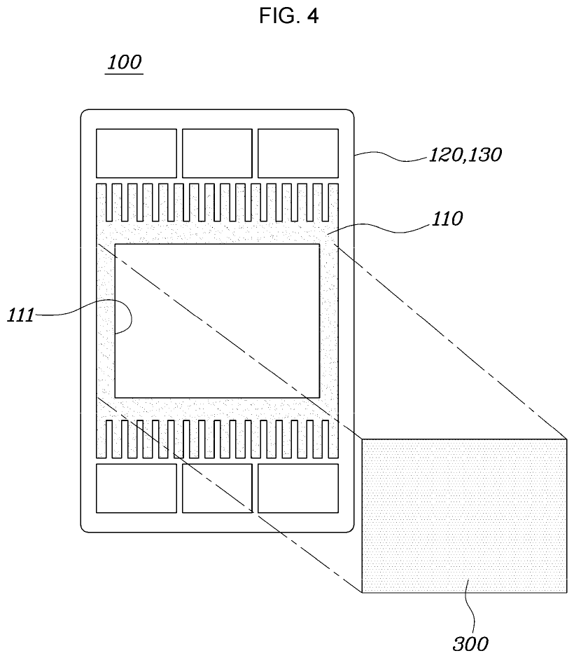

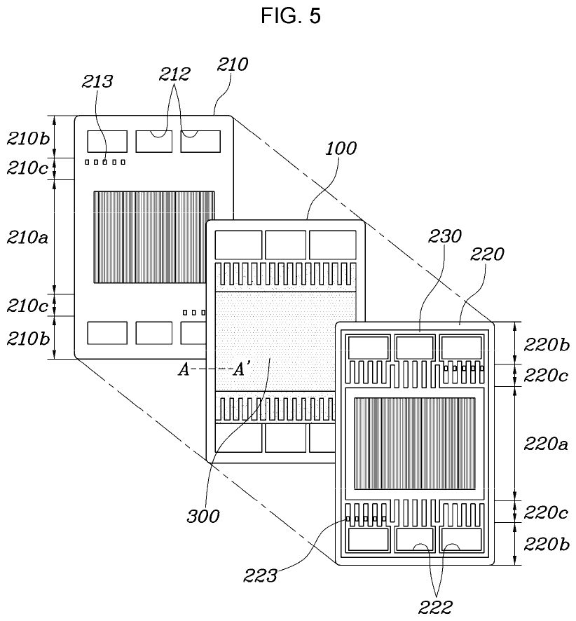

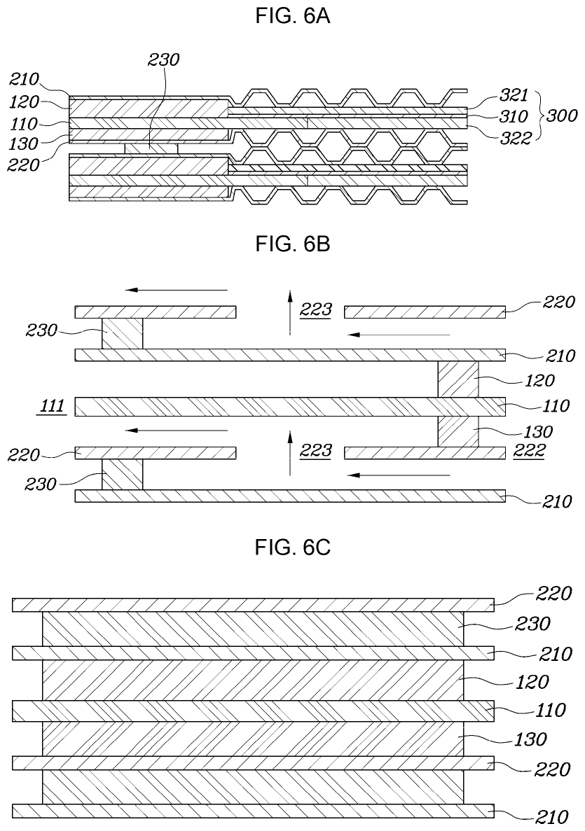

FIG. 2 is a view showing a sheet frame module according to an exemplary embodiment of the present disclosure, FIG. 3A, FIG. 3B and FIG. 3C are views showing each sheet frame forming a sheet frame module according to an exemplary embodiment of the present disclosure, FIG. 4 is a view showing a sheet frame module and EGA according to an exemplary embodiment of the present disclosure, FIG. 5 is a view showing a unit cell for a fuel cell according to an exemplary embodiment of the present disclosure, FIG. 6A, FIG. 6B, and FIG. 6C are cross-sectional views of main portions of a unit cell for a fuel cell according to an exemplary embodiment of the present disclosure.

In the instant case, FIG. 3A is a view showing a center sheet frame forming a sheet frame module according to an exemplary embodiment of the present disclosure, FIG. 3B is a view showing a first side sheet frame forming a sheet frame module according to an exemplary embodiment of the present disclosure, and FIG. 3C is a view showing a second side sheet frame forming a sheet frame module according to an exemplary embodiment of the present disclosure.

Furthermore, FIG. 6A is a cross-sectional view taken along line A-A′ of FIG. 5, FIG. 6B is a cross-sectional view taken along line B-B′ of FIG. 5, and FIG. 6C is a cross-sectional view taken along line C-C′ of FIG. 5.

A unit cell for a fuel cell according to an exemplary embodiment of the present disclosure roughly includes an EGA 300, a first separator 210, a second separator 220, and a sheet frame module 100.

The electrode gas diffusion layer assembly (EGA) 300 is an assembly in which a pair of gas diffusion layers 321 and 322 is bonded to both sides of the membrane electrode assembly 310.

A membrane electrode assembly and a pair of gas diffusion layers commonly applied to a unit cell for a general fuel cell is applied for the membrane electrode assembly 310 and pair of gas diffusion layers 321 and 322 forming the EGA 300. However, in the exemplary embodiment of the present disclosure, as shown in FIG. 6A, compared to the size of the membrane electrode assembly 310, the first gas diffusion layer 321 disposed on one side of the membrane electrode assembly 310 is formed as the same size as the membrane electrode assembly 310, and the edge portion of the second gas diffusion layer 322 disposed on the other side of the membrane electrode assembly 310 is formed to be smaller than the size of the membrane electrode assembly 310. Therefore, a step is formed on the other side of the EGA 300 due to the difference in size between the membrane electrode assembly 310 and the second gas diffusion layer 322, and the bonding with the sheet frame module 100 is facilitated using the step formed in the present way.

Furthermore, an anode separator and a cathode separator in a form applied to a unit cell for a general fuel cell are applied to the first separator 210 and the second separator 220. However, because the first separator 210 and the second separator 220 are provided with the sheet frame module 100, in place of the gasket formed on the surfaces of the general anode separator and cathode separator by injection molding, the exemplary embodiment of the present disclosure does not form part or all of the gasket formed on the first separator 210 and the second separator 220. In the exemplary embodiment of the present disclosure, the gasket formed on the reaction surface opposite to the EGA 300 among both sides of the first separator 210 and second separator 220 is omitted. Furthermore, a gasket 230 forming an airtight line and flow path of cooling water is formed only on the cooling surface of one of the first separator 210 and the second separator 220. Here, the gasket may be formed on any of the first separator 210 and the second separator 220.

Meanwhile, in the exemplary embodiment of the present disclosure, the first separator 210 corresponds to an anode separator of a general unit cell, and the second separator 220 corresponds to a cathode separator of a general unit cell. It is obvious that the first separator 210 is not limited to an anode separator and may be a cathode separator, and the second separator 220 is not limited to a cathode separator and may also be an anode separator.

Next, the sheet frame module according to an exemplary embodiment of the present disclosure will be described in detail.

The sheet frame module 100 according to an exemplary embodiment of the present disclosure shown in FIG. 2 and FIG. 3A, FIG. 3B and FIG. 3C includes a center sheet frame 110 in which the membrane electrode assembly 310 or the EGA 300 (hereinafter, description is made for EGA) is disposed in a center portion thereof; a first side sheet frame 120 disposed between one side of the center sheet frame 110 and the first separator 210 to form an airtight line and flow path of a first reaction gas; and a second side sheet frame 130 disposed between the other side of the center sheet frame 110 and the second separator 220 to form an airtight line and flow path of a second reaction gas.

Here, the center sheet frame 110, the first side sheet frame 120, and the second side sheet frame 130 are each formed in a flat sheet shape.

As shown in FIG. 3A, the center sheet frame 110 includes a configuration in which the EGA 300 is disposed and bonded, and is divided into a center reaction area 110a in the center portion and center manifold areas 110b on both sides.

In the instant case, a mounting hole 111 is formed in the center reaction area 110a, so that at least a portion of the edge portion of the EGA 300 is mounted on the edge portion of the mounting hole 111, and both surfaces of the EGA 300 are exposed through the mounting hole 111. Here, the step area formed by the difference in size between the membrane electrode assembly 310 and second gas diffusion layer 322 forming the EGA 300 is placed at the edge portion of the mounting hole 111, so that the center sheet frame 110 and the EGA 300 are securely stacked and bonded. In the instant case, the center sheet frame 110 is formed with the same thickness as the second gas diffusion layer 322 or the thickness slightly thinner than that of the second gas diffusion layer 322, and is formed in a size corresponding to the mounting hole 111, so that the second gas diffusion layer 322 is disposed on the internal circumferential surface of the mounting hole 111, the surfaces of the center sheet frame 110 and second gas diffusion layer 322 form a same plane, or the second gas diffusion layer 322 slightly protrudes from the center sheet frame 110 in the thickness direction thereof.

Thus, in the case that the center frame 110 is stacked and compressed between the first separator 210 and the second separator 220, together with the first side sheet frame 120, the second side sheet frame 130, and the EGA 300, as the second gas diffusion layer 322 is compressed by the thickness difference between the center sheet frame 110 and the second gas diffusion layer 322 to form a unit cell, the surfaces of the center sheet frame 110 and second gas diffusion layer 322 become a same plane.

Furthermore, a plurality of center manifold holes 112 is formed through the pair of center manifold areas 110b formed on both sides of the center reaction area 110a so that the reaction gas or cooling water flows.

Furthermore, the first side sheet frame 120 and the second side sheet frame 130 are configured to form the airtight line and flow path of the reaction gas, and are formed in shapes that correspond to each other.

In other words, as shown in FIG. 3B, the first side sheet frame 120 includes a first side reaction area 120a formed with a first reaction area hole 121 greater than the mounting hole 111 in the center portion thereof, and a pair of first side manifold areas 120b formed with a plurality of first side manifold holes 122 fluidically-communicating with the center manifold hole 112 on both sides of the first side reaction area 120a.

Also, the first side sheet frame 120 includes a pair of first side flow path areas 120c forming a flow path of reaction gas between the first side reaction area 120a and the pair of first side manifold areas 120b.

In the instant case, the first side flow path area 120c of the first side sheet frame 120 includes a plurality of first flow paths 123 extending from the first reaction area hole 121 to be adjacent to the first side manifold hole 122, and a plurality of first ribs 124 disposed between the plurality of first flow paths 123.

Furthermore, as shown in FIG. 3C, the second side sheet frame 130 also includes a second side reaction area 130a formed with a second reaction area hole 131 greater than the mounting hole 111 in the center portion thereof, and a pair of second side manifold areas 130b formed with a plurality of second side manifold holes 132 fluidically-communicating with the center manifold hole 112 on both sides of the second side reaction area 130a.

Also, the second side sheet frame 130 includes a pair of second side flow path areas 130c forming a flow path of reaction gas between the second side reaction area 130a and the pair of second side manifold areas 130b.

In the instant case, the second side flow path area 130c of the second side sheet frame 130 includes a plurality of second flow paths 133 extending from the second reaction area hole 131 to be adjacent to the second side manifold hole 132, and a plurality of second ribs 134 disposed between the plurality of second flow paths 133.

The first flow path 123 formed on the first side sheet frame 120 and the second flow path 133 formed on the second side sheet frame 130 are formed at positions overlapping each other.

Similarly, a first rib 124 formed on the first side sheet frame 120 and a second rib 134 formed on the second side sheet frame 130 are also formed at positions overlapping each other.

In the instant case, the shapes of the first flow path 123, the second flow path 133, the first rib 124, and the second rib 134 may be implemented by changing into various shapes according to the flow path of the reaction gas.

On the other hand, as described above, the center sheet frame 110, the first side sheet frame 120, and the second side sheet frame 130 may be applied with the same or different materials.

For example, all of the center sheet frame 110, the first side sheet frame 120, and the second side sheet frame 130 may be applied with a material of high hardness, so an even cell pitch may be maintained in each unit cell when a plurality of unit cells is stacked and fastened.

Alternatively, the center sheet frame 110 is applied with a material of higher hardness than that of the first side sheet frame 120 and second side sheet frame 130, and the first side sheet frame 120 and the second side sheet frame 130 are applied with a material of higher elasticity than that of the center sheet frame 110, so that deformation resistance and airtight performances may be enhanced.

Meanwhile, as shown in FIG. 5, the first separator 210 also includes a first separator reaction area 210a formed in the center portion thereof, and a pair of first separator manifold areas 210b through which a plurality of first separator manifold holes 212 is passed so that reaction gas or cooling water flows to both sides of the first separator reaction area 210a.

Furthermore, the second separator 220 also includes a second separator reaction area 220a formed in the center portion thereof, and a pair of second separator manifold areas 220b through which a plurality of second separator manifold holes 222 is passed so that reaction gas or cooling water flows to both sides of the second separator reaction area 220a.

In the instant case, the first separator manifold hole 212 and the second separator manifold hole 222 communicate with the center manifold hole 112, the first side manifold hole 122, and the second side manifold hole 132.

Furthermore, the first separator 210 includes a pair of first separator flow path areas 210c forming a flow path of the first reaction gas between the first separator reaction area 210a and the pair of first separator manifold areas 210b.

In the instant case, the first separator flow path area 210c includes a plurality of first flow path holes 213 through which the first reaction gas flows. The first flow path hole 213 is formed in a portion of the area overlapping the area where the first flow path 123 of the first side sheet frame 120 is formed.

Similarly, the second separator 220 includes a pair of second separator flow path areas 220c forming a flow path of the second reaction gas between the second separator reaction area 220a and the pair of second separator manifold area 220b.

In the instant case, the second separator flow path area 220c includes a plurality of second flow path holes 223 through which the second reaction gas flows, and the second flow path hole 223 is formed in a portion of an area overlapping the area where the second flow path 133 is formed.

Meanwhile, in the exemplary embodiment of the present disclosure, the center sheet frame 110, the first side sheet frame 120, and the second side sheet frame 130 forming the sheet frame module are disposed between the first separator 210 and the second separator 220 in a state they are stacked, and their positions may be fixed by pressing force or bonded by a separate adhesive upon stacking.

Furthermore, the center sheet frame 110, the first side sheet frame 120, and the second side sheet frame 130 may stacked and compressed while applying heat, so that they may be bonded to each other by heat without a separate adhesive.

Furthermore, the sheet frame module 100, and the first separator 210 and the second separator 220 may also be fixed in their positions by pressing each other or bonded to each other by a separate adhesive upon the stacking.

Furthermore, the mounting hole 111 and the center manifold hole 112 formed in the center sheet frame 110 are formed by punching a sheet-shaped material into a desired shape.

Similarly, the first reaction area hole 121, the first side manifold hole 122, and the first flow path 123, and the second reaction area hole 131, the second side manifold hole 132, and the second flow path 133 formed in the first side sheet frame 120 and the second side sheet frame 130 are also formed by punching a sheet-shaped material into a desired shape.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A sheet frame module which is disposed between a pair of separators for a fuel cell to form an airtight line and flow path of reaction gas, the sheet frame module comprising:
a center sheet frame in which a membrane electrode assembly is disposed at a center portion thereof;
a first side sheet frame disposed between a first side of the center sheet frame and one of the pair of separators to form an airtight line and flow path of a first reaction gas; and
a second side sheet frame disposed between a second side of the center sheet frame and another of the pair of separators to form an airtight line and flow path of a second reaction gas.

2. The sheet frame module of claim 1, wherein the center sheet frame includes:
a center reaction area in which a mounting hole is formed in the center portion, and first and second surfaces of the membrane electrode assembly are exposed through the mounting hole while at least a portion of an edge portion of the membrane electrode assembly is mounted on an edge portion of the mounting hole; and
a pair of center manifold areas through which a plurality of center manifold holes is passed so that reaction gas or cooling water flows to first and second sides of the center reaction area.

3. The sheet frame module of claim 2,
wherein the first side sheet frame includes a first side reaction area formed with a first reaction area hole in a center portion thereof, and a pair of first side manifold areas formed with a plurality of first side manifold holes fluidically-communicating with a center manifold hole on first and second sides of the first side reaction area,
wherein the second side sheet frame includes a second side reaction area formed with a second reaction area hole in a center portion thereof, and a pair of second side manifold areas formed with a plurality of second side manifold holes fluidically-communicating with the center manifold hole on first and second sides of the second side reaction area.

4. The sheet frame module of claim 3,
wherein the first reaction area hole is greater than the mounting hole, and
wherein the second reaction area hole is greater than the mounting hole.

5. The sheet frame module of claim 3,
wherein the first side sheet frame includes a pair of first side flow path areas forming a flow path of the reaction gas between the first side reaction area and the pair of first side manifold areas, and
wherein the second side sheet frame includes a pair of second side flow path areas forming a flow path of the reaction gas between the second side reaction area and the pair of second side manifold areas.

6. The sheet frame module of claim 5,
wherein the first side flow path area of the first side sheet frame includes a plurality of first flow paths extending from the first reaction area hole to be adjacent to the first side manifold holes and a plurality of first ribs disposed between the plurality of first flow paths, and
wherein the second side flow path area of the second side sheet frame include a plurality of second flow paths extending from the second reaction area hole to be adjacent to the second side manifold holes and a plurality of second ribs disposed between the plurality of second flow paths.

7. The sheet frame module of claim 6,
wherein the first flow paths and the second flow paths are formed at positions overlapping each other, and
wherein the first ribs and the second ribs are formed at positions overlapping each other.

8. The sheet frame module of claim 1, wherein the center sheet frame, the first side sheet frame, and the second side sheet frame are each formed in a shape of a flat sheet.

9. The sheet frame module of claim 1, wherein the center sheet frame, the first side sheet frame, and the second side sheet frame are formed of a same material.

10. The sheet frame module of claim 1, wherein the center sheet frame is formed of a material with higher hardness than a hardness of the first side sheet frame and the second side sheet frame.

11. The sheet frame module of claim 1, wherein the first side sheet frame and the second side sheet frame are formed of a material with higher elasticity than an elasticity of the center sheet frame.

12. A unit cell for a fuel cell, the unit cell comprising:
an electrode gas diffusion layer assembly (EGA) in which a pair of gas diffusion layers is bonded to first and second sides of a membrane electrode assembly;
a first separator disposed on a first side of the EGA;
a second separator disposed on a second side of the EGA;
a center sheet frame in which the EGA is disposed in a center portion thereof;
a first side sheet frame disposed between a first side of the center sheet frame and the first separator to form an airtight line and flow path of a first reaction gas; and
a second side sheet frame disposed between a second side of the center sheet frame and the second separator to form an airtight line and flow path of a second reaction gas.

13. The unit cell of claim 12,
wherein the center sheet frame includes a center reaction area in which a mounting hole is formed in a center portion thereof, and first and second surfaces of the EGA are exposed through the mounting hole while at least a portion of an edge portion of the EGA is mounted on an edge portion of the mounting hole, and a pair of center manifold areas through which a plurality of center manifold holes is passed so that reaction gas or cooling water flows to first and second sides of the center reaction area,
wherein the first side sheet frame includes a first side reaction area formed with a first reaction area hole in a center portion thereof, and a pair of first side manifold areas formed with a plurality of first side manifold holes fluidically-communicating with a center manifold hole on first and second sides of the first side reaction area, and
wherein the second side sheet frame includes a second side reaction area formed with a second reaction area hole in a center portion thereof, and a pair of second side manifold areas formed with a plurality of second side manifold holes fluidically-communicating with the center manifold holes on first and second sides of the second side reaction area.

14. The unit cell of claim 13,
wherein the first reaction area hole is greater than the mounting hole, and
wherein the second reaction area hole is greater than the mounting hole.

15. The unit cell of claim 13,
wherein the first separator includes a first separator reaction area formed in a center portion thereof, and a pair of first separator manifold areas through which a plurality of first separator manifold holes is passed so that reaction gas or cooling water flows to first and second sides of the first separator reaction area,
wherein the second separator includes a second separator reaction area formed in a center portion thereof, and a pair of second separator manifold areas through which a plurality of second separator manifold holes is passed so that reaction gas or cooling water flows to first and second sides of the second separator reaction area, and
wherein the first separator manifold holes and the second separator manifold holes communicate with the center manifold holes.

16. The unit cell of claim 15,
wherein the first side sheet frame includes a pair of first side flow path areas forming a flow path of the first reaction gas between the first side reaction area and the pair of first side manifold areas,
wherein each first side flow path area includes a plurality of first flow paths extending from the first reaction area hole to be adjacent to the first side manifold holes and a plurality of first ribs disposed between the plurality of first flow paths,
wherein the first separator includes a pair of first separator flow path areas forming a flow path of the first reaction gas between the first separator reaction area and the pair of first separator manifold areas,
wherein each first separator flow path area includes a plurality of first flow path holes through which the first reaction gas flows, and
wherein the first flow path holes are formed in a portion of an area overlapping an area where the first flow paths are formed.

17. The unit cell of claim 15,
wherein the second side sheet frame includes a pair of second side flow path areas forming a flow path of the second reaction gas between the second side reaction area and the pair of second side manifold areas,
wherein each second side flow path area include a plurality of second flow paths extending from the second reaction area hole to be adjacent to the second side manifold holes and a plurality of second ribs disposed between the plurality of second flow paths,
wherein the second separator includes a pair of second separator flow path areas forming a flow path of the second reaction gas between the second separator reaction area and the pair of second separator manifold areas,
wherein each second separator flow path area includes a plurality of second flow path holes through which the second reaction gas flows, and
wherein the second flow path holes are formed in a portion of an area overlapping an area where the second flow paths are formed.

18. The unit cell of claim 12, wherein one of the gas diffusion layers of the EGA is formed in a size corresponding to a mounting hole of the center sheet frame and disposed on an internal circumferential surface of the mounting hole.

19. The unit cell of claim 18, wherein among the gas diffusion layers of the EGA, the gas diffusion layer disposed on the internal circumferential surface of the mounting hole is formed to have a same thickness as the center sheet frame.
